(19) United States
(12) Patent Application Publication
(10) Pub. No.: US 2022/0207897 A1
(43) Pub. Date: Jun. 30, 2022

(54) SYSTEMS AND METHODS FOR AUTOMATIC LABELING OF OBJECTS IN 3D POINT CLOUDS

(71) Applicant: BEIJING VOYAGER TECHNOLOGY CO., LTD., Beijing (CN)

(72) Inventor: Cheng ZENG, Beijing (CN)

(73) Assignee: BEIJING VOYAGER TECHNOLOGY CO., LTD., Beijing (CN)

(21) Appl. No.: 17/674,784

(22) Filed: Feb. 17, 2022

Related U.S. Application Data
(63) Continuation of application No. PCT/CN2019/109323, filed on Sep. 30, 2019.

(51) Int. Cl. G06V 20/70; G06V 20/58; G06T 7/70; G01S 17/89

(52) U.S. Cl. CPC G06V 20/70; G06V 20/58; G06T 2207/30252; G01S 17/89; G06T 2207/10028; G06T 7/70

(57) ABSTRACT

Embodiments of the disclosure provide methods and systems for labeling an object in point clouds. The system may include a storage medium configured to store a sequence of plural sets of 3D point cloud data acquired by one or more sensors associated with a vehicle. The system may further include one or more processors configured to receive two sets of 3D point cloud data that each includes a label of the object. The two sets of data are not adjacent to each other in the sequence. The processors may be further configured to determine, based at least partially upon the difference between the labels of the object in the two sets of 3D point cloud data, an estimated label of the object in one or more sets of 3D point cloud data in the sequence that are acquired between the two sets of the 3D point cloud data.

### CROSS-REFERENCE TO RELATED APPLICATIONS

This application is a bypass continuation to PCT Application No. PCT/CN2019/109323, filed Sep. 30, 2019, the content of which is hereby incorporated by reference in its entirety.

### TECHNICAL FIELD

The present disclosure relates to systems and methods for automatic labeling of objects in three-dimensional (“3D”) point clouds, and more particularly to, systems and methods for automatic labeling of objects in 3D point clouds during mapping of surrounding environments by autonomous driving vehicles.

### BACKGROUND

Autonomous driving has recently become a popular subject of technological evolution in the car industry and the artificial intelligence field. As its name suggests, a vehicle capable of autonomous driving, or a “self-driving vehicle,” may drive on the road partially or completely without the supervision of an operator, with an aim to allow the operator to focus his attention on other matters and to save time. According to the classification by the National Highway Traffic Safety Administration (NHTSA) of the US Department of Transportation, there are currently five different levels of autonomous driving, from Level 1 to Level 5. Level 1 is the lowest level under which most functions are controlled by the driver except for some basic operations (e.g., accelerating or steering). The higher the level, the higher degree of autonomy the vehicle is able to achieve.

Starting from Level 3, a self-driving vehicle is expected to shift “safety-critical functions” to the autonomous driving system under certain road conditions or environments, while the driver may need to take over control of the vehicle in other situations. As a result, the vehicle has to be equipped with artificial intelligence functionality for sensing and mapping the surrounding environment. For example, cameras are traditionally used onboard to take two-dimensional (2D) images of surrounding objects. However, 2D images alone may not generate sufficient data for detecting depth information of the objects, which is critical for autonomous driving in a three-dimensional (3D) world.

In the past few years, developers in the industry began the trial use of a Light Detection and Ranging (LiDAR) scanner on top of a vehicle to acquire the depth information of the objects along the travel trajectory of the vehicle. A LiDAR scanner emits pulsed laser light towards different directions and measures the distance of objects in those directions by receiving reflected light with a sensor. Thereafter, the distance information is converted into 3D point clouds that digitally represent the environment around the vehicle. Problems arise when various objects move at a speed relative to the vehicle, because tracking of these objects requires them to be annotated in a massive amount of 3D point clouds, therefore empowering the vehicle to recognize them in real-time. Currently, the objects are manually labeled by human beings for tracking purpose. Manual labeling requires a significant amount of time and labor, thus making environment mapping and sensing costly.

Consequently, to address the above problems, systems and methods for automatic labeling of the objects in 3D point clouds are disclosed herein.

### SUMMARY

Embodiments of the disclosure provide a system for labeling an object in point clouds. The system may include a storage medium configured to store a sequence of plural sets of 3D point cloud data acquired by one or more sensors associated with a vehicle. Each set of 3D point cloud data is indicative of a position of the object in a surrounding environment of the vehicle. The system may further include one or more processors. The processors may be configured to receive two sets of 3D point cloud data that each includes a label of the object. The two sets of 3D point cloud data are not adjacent to each other in the sequence. The processors may be further configured to determine, based at least partially upon the difference between the labels of the object in the two sets of 3D point cloud data, an estimated label of the object in one or more sets of 3D point cloud data in the sequence that are acquired between the two sets of the 3D point cloud data.

According to the embodiments of the disclosure, the storage medium may be further configured to store a plurality of frames of 2D images of the surrounding environment of the vehicle. The 2D images are captured by an additional sensor associated with the vehicle while the one or more sensors is acquiring the sequence of plural sets of 3D point cloud data. At least some of the frames of 2D images include the object. The processors may be further configured to associate the plural sets of 3D point cloud data with the respective frames of 2D images.

Embodiments of the disclosure also provide a method for labeling an object in point clouds. The method may include acquiring a sequence of plural sets of 3D point cloud data. Each set of 3D point cloud data is indicative of a position of an object in a surrounding environment of a vehicle. The method may also include receiving two sets of 3D point cloud data in which the object is labeled. The two sets of 3D point cloud data are not adjacent to each other in the sequence. The method may further include determining, based at least partially upon the difference between the labels of the object in the two sets of 3D point cloud data, an estimated labeling of the object in one or more sets of 3D point cloud data in the sequence that are acquired between the two sets of the 3D point cloud data.

According to the embodiments of the disclosure, the method may also include capturing, while acquiring the sequence of plural sets of 3D point cloud data, a plurality of frames of 2D images of the surrounding environment of the vehicle. The frames of 2D images include the object. The method may further include associating the plural sets of 3D point cloud data with the respective frames of 2D images.

Embodiments of the disclosure further provide a non-transitory computer-readable medium having instructions stored thereon that, when executed by one or more processors, causes the one or more processors to perform operations. The operations may include acquiring a sequence of plural sets of 3D point cloud data. Each set of 3D point cloud data is indicative of a position of an object in a surrounding environment of a vehicle. The operations may also include receiving two sets of 3D point cloud data in which the object is labeled. The two sets of 3D point cloud data are not adjacent to each other in the sequence. The operations may further include determining, based at least partially upon the difference between the labels of the object in the two sets of 3D point cloud data, an estimated labeling of the object in one or more sets of 3D point cloud data in the sequence that are acquired between the two sets of the 3D point cloud data.

According to the embodiments of the disclosure, the operations may also include capturing, while acquiring the sequence of plural sets of 3D point cloud data, a plurality of frames of 2D images of the surrounding environment of the vehicle. The frames of 2D images include the object. The operations may further include associating the plural sets of 3D point cloud data with the respective frames of 2D images.

It is to be understood that both the foregoing general descriptions and the following detailed descriptions are exemplary and explanatory only and are not restrictive of the invention, as claimed.

### BRIEF DESCRIPTION OF THE DRAWINGS

FIG. 1 illustrates a schematic diagram of an exemplary vehicle equipped with sensors, according to embodiments of the disclosure.

FIG. 2 illustrates a block diagram of an exemplary system for automatic labeling objects in 3D points clouds, according to embodiments of the disclosure.

FIG. 3A illustrates an exemplary 2D image captured by an imaging sensor onboard the vehicle of FIG. 1, according to embodiments of the disclosure.

FIG. 3B illustrates an exemplary set of point cloud data associated with the exemplary 2D image in FIG. 3A, according to embodiments of the disclosure.

FIG. 3C illustrates an exemplary top view of the point cloud data set in FIG. 3B, according to embodiments of the disclosure.

FIG. 4 illustrates a flow chart of an exemplary method for labeling an object in point clouds, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

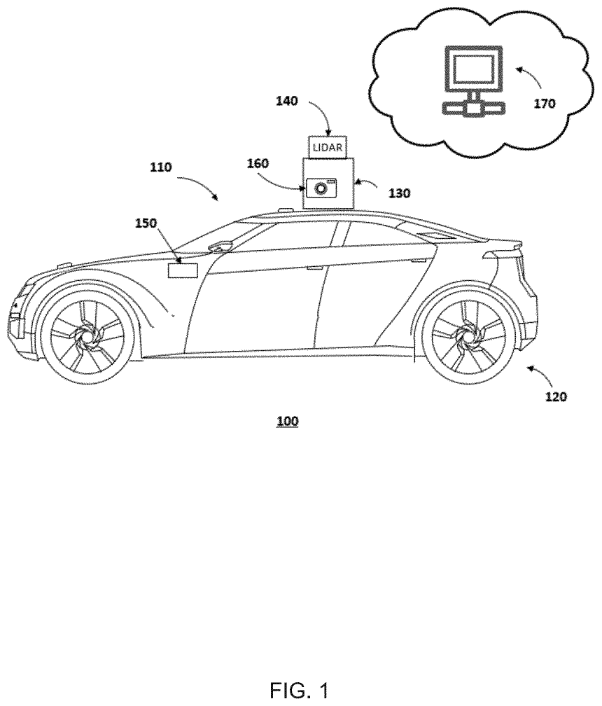

FIG. 1 illustrates a schematic diagram of an exemplary vehicle 100 equipped with a plurality of sensors 140, 150 and 160, according to embodiments of the disclosure. Consistent with some embodiments, vehicle 100 may be a survey vehicle configured for acquiring data for constructing a high-resolution map or three-dimensional (3-D) city modeling. It is contemplated that vehicle 100 may be an electric vehicle, a fuel cell vehicle, a hybrid vehicle, or a conventional internal combustion engine vehicle. Vehicle 100 may have a body 110 and at least one wheel 120. Body 110 may be any body style, such as a toy car, a motorcycle, a sports vehicle, a coupe, a convertible, a sedan, a pick-up truck, a station wagon, a sports utility vehicle (SUV), a minivan, a conversion van, a multi-purpose vehicle (MPV), or a semi-trailer truck. In some embodiments, vehicle 100 may include a pair of front wheels and a pair of rear wheels, as illustrated in FIG. 1. However, it is contemplated that vehicle 100 may have less or more wheels or equivalent structures that enable vehicle 100 to move around. Vehicle 100 may be configured to be all wheel drive (AWD), front wheel drive (FWR), or rear wheel drive (RWD). In some embodiments, vehicle 100 may be configured to be operated by an operator occupying the vehicle, remotely controlled, and/or autonomous. There is no specific requirement for the seating capacity of vehicle 100, which can be any number from zero.

As illustrated in FIG. 1, vehicle 100 may be equipped with various sensors 140 and 160 mounted to body 110 via a mounting structure 130. Mounting structure 130 may be an electro-mechanical device installed or otherwise attached to body 110 of vehicle 100. In some embodiments, mounting structure 130 may use screws, adhesives, or another mounting mechanism. In other embodiments, sensors 140 and 160 may be installed on the surface of body 110 of vehicle 100, or embedded inside vehicle 100, as long as the intended functions of these sensors are carried out.

Consistent with some embodiments, sensors 140 and 160 may be configured to capture data as vehicle 100 travels along a trajectory. For example, sensor 140 may be a LiDAR scanner that scans the surrounding and acquires point clouds. More specifically, sensor 140 continuously emits laser light into the environment and receives returned pulses from a range of directions. The light used for LiDAR scan may be ultraviolet, visible, or near infrared. Because a narrow laser beam can map physical features with very high resolution, a LiDAR scanner is particularly suitable for high-resolution positioning.

An example of an off-the-shelf LiDAR scanner may emit 16 or 32 laser beams and map the environment using point clouds at a typical rate of 300,000 to 600,000 points per second, or even more. Therefore, depending on the complexity of the environment to be mapped by sensor 140 and the degree of granularity the voxel image requires, a set of 3D point cloud data may be acquired by sensor 140 within a matter of seconds or even less than a second. For example, for one voxel image with a point density of 60,000 to 120,000 points, each set of point cloud data can be fully generated in about ⅕ second by the above exemplary LiDAR. As the LiDAR scanner continues to operate, a sequence of plural sets of 3D point cloud data may be generated accordingly. In the above example of the off-the-shelf LiDAR scanner, five sets of 3D point cloud data may be generated by the exemplary LiDAR scanner in about one second. A five-minute continuous surveying of the environment surrounding vehicle 100 by sensor 140 may generate about 1,500 sets of point cloud data. With the teaching of the current disclosure, a person of ordinary skill in the art would know how to choose from different LiDAR scanners available on the market to obtain voxel images with different pixel density requirement or speed of generating point cloud data.

When vehicle 100 moves, it may create relative movements between vehicle 100 and the objects in the surrounding environment, such as trucks, cars, bikes, pedestrians, trees, traffic signs, buildings, and lamps. Such movements may be reflected in the plurality sets of 3D point clouds, as the spatial positions of the objects change among different sets. Relative movements may also take place when the objects themselves are moving when vehicle 100 is not. Therefore, the position of an object in one set of 3D point cloud data may be different from that of the same object in a different set of 3D point cloud data. Accurate and fast positioning of such objects that move relatively to vehicle 100 contributes to the improvement of the safety and accuracy of autonomous driving, so that vehicle 100 may decide how to adjust speed and/or direction to avoid collision with these objects, or to deploy safety mechanisms in advance to reduce potential bodily and property damages in the event a collision becomes imminent.

Consistent with the present disclosure, vehicle 100 may be additionally equipped with sensor 160 configured to capture digital images, such as one or more cameras. In some embodiments, sensor 160 may include a panoramic camera with 360-degree FOV or a monocular camera with FOV less than 360 degrees. As vehicle 100 moves along a trajectory, digital images with respect to a scene (e.g., including objects surrounding vehicle 100) can be acquired by sensor 160. Each image may include textual information of the objects in the captured scene represented by pixels. Each pixel may be the smallest single component of a digital image that is associated with color information and coordinates in the image. For example, the color information may be represented by the RGB color model, the CMYK color model, the YCbCr color model, the YUV color model, or any other suitable color model. The coordinates of each pixel may be represented by the rows and columns of the array of pixels in the image. In some embodiments, sensor 160 may include multiple monocular cameras mounted at different locations and/or in different angles on vehicle 100 and thus, have varying view positions and/or angles. As a result, the images may include front view images, side view images, top view images, and bottom view images.

As illustrated in FIG. 1, vehicle 100 may be further equipped with sensor 150, which may be one or more sensors used in a navigation unit, such as a GPS receiver and/or one or more IMU sensors. Sensor 150 can be embedded inside, installed on the surface of, or mounted outside of body 110 of vehicle 100, as long as the intended functions of sensor 150 are carried out. A GPS is a global navigation satellite system that provides geolocation and time information to a GPS receiver. An IMU is an electronic device that measures and provides a vehicle's specific force, angular rate, and sometimes the magnetic field surrounding the vehicle, using various inertial sensors, such as accelerometers and gyroscopes, sometimes also magnetometers. By combining the GPS receiver and the IMU sensor, sensor 150 can provide real-time pose information of vehicle 100 as it travels, including the positions and orientations (e.g., Euler angles) of vehicle 100 at each time stamp.

Consistent with some embodiments, a server 170 may be communicatively connected with vehicle 100. In some embodiments, server 170 may be a local physical server, a cloud server (as illustrated in FIG. 1), a virtual server, a distributed server, or any other suitable computing device. Server 170 may receive data from and transmit data to vehicle 100 via a network, such as a Wireless Local Area Network (WLAN), a Wide Area Network (WAN), wireless networks such as radio waves, a nationwide cellular network, a satellite communication network, and/or a local wireless network (e.g., Bluetooth™ or WiFi).

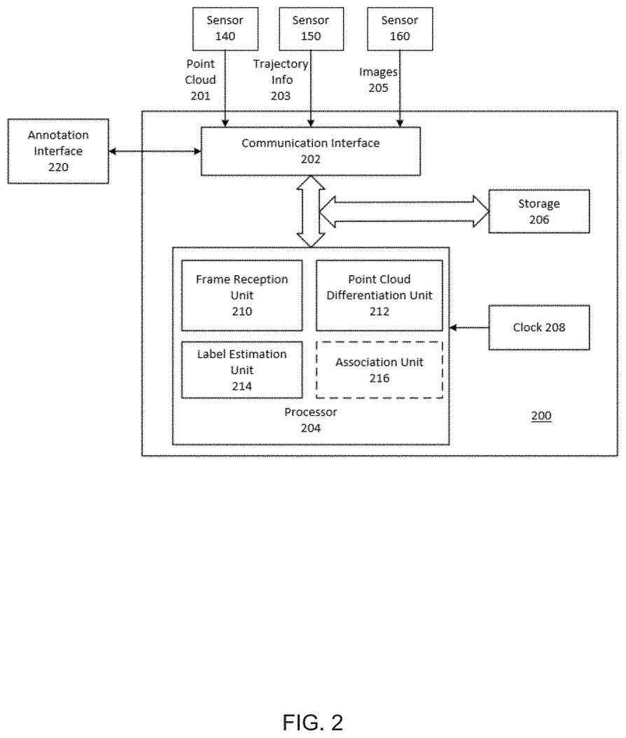

The system according to the current disclosure may be configured to automatically label an object in point clouds without manual input of the labeling information. FIG. 2 illustrates a block diagram of an exemplary system 200 for automatic labeling objects in 3D points clouds, according to embodiments of the disclosure.

System 200 may receive point cloud 201 converted from sensor data captured by a sensor 140. Point cloud 201 may be obtained by digitally processing the returned laser light with a processor onboard vehicle 100 and coupled to sensor 140. The processor may further convert the 3D point cloud into a voxel image that approximates the 3D depth information of the surrounding of vehicle 100. Subsequent to the processing, a user-viewable digital representation associated with vehicle 100 may be provided with the voxel image. The digital representation may be displayed on a screen (now shown) onboard vehicle 100 that is coupled to system 200. It may also be stored in a storage or memory and later accessed by an operator or user at a location different from vehicle 100. For example, the digital representation in the storage or memory may be transferred to a flash drive or a hard drive coupled to system 200, and subsequently imported to another system for display and/or processing.

In some other embodiments, the acquired data may be transmitted from vehicle 100 to a remotely located processor such as server 170, which converts the data into 3D point cloud and then into a voxel image. After processing, one or both of point cloud 201 and the voxel image may be transmitted back to vehicle 100 for assisting autonomous driving controls or for system 200 to store.

Consistent with some embodiments according to the current disclosure, system 200 may include a communication interface 202, which may send data to and receive data from components such as sensor 140 via cable or wireless networks. Communication interface 202 may also transfer data with other components within system 200. Examples of such components may include a processor 204 and a storage 206.

Storage 206 may include any appropriate type of mass storage that stores any type of information that processor 204 may need to operate. Storage 206 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Storage 206 may be configured to store one or more computer programs that may be executed by processor 204 to perform various functions disclosed herein.

Processor 204 may include any appropriate type of general-purpose or special-purpose microprocessor, digital signal processor, or microcontroller. Processor 204 may be configured as a separate processor module dedicated to performing one or more specific functions. Alternatively, processor 204 may be configured as a shared processor module for performing other functions unrelated to the one or more specific functions. As shown in FIG. 2, processor 204 may include multiple modules, such as a frame reception unit 210, a point cloud differentiation unit 212, and a label estimation unit 214. These modules (and any corresponding sub-modules or sub-units) can be hardware units (e.g., portions of an integrated circuit) of processor 204 designed for use with other components or to execute a part of a program. Although FIG. 2 shows units 210, 212, and 214 all within one processor 204, it is contemplated that these units may be distributed among multiple processors located near or remotely coupled with each other.

Consistent with some embodiments according to the current disclosure, system 200 may be coupled to an annotation interface 220. As indicated above, tracking of objects with relative movements to an autonomous vehicle is important for the vehicle to understand the surrounding environment. When it comes to point cloud 201, this may be done by annotating or labeling each distinct object detected in point cloud 201. Annotation interface 220 may be configured to allow a user to view a set of 3D point cloud data displayed as a voxel image on one or more screens. It may also include an input device, such as a mouse, a keyboard, a remote controller with motion detection capability, or any combination of these, for the user to annotate or label the object he chooses to track in point cloud 201. By way of example, system 200 may transmit point cloud 201 via cable or wireless networks by communication interface 202 to annotation interface 220 for display. Upon viewing the voxel image of the 3D point cloud data containing a car on the screen of annotation interface 220, the user may draw a bounding box (e.g. a rectangular block, a circle, a cuboid, a sphere, etc.) with the input device to cover a substantial or entire portion of the car in the 3D point cloud data. Although the labeling may be performed manually by the user, the current disclosure does not require manual annotation of each set of 3D point cloud. Indeed, due to the large number of sets of point cloud data captured by sensor 140, to manually label the object in every set would dramatically increase time and labor, which may not be efficient for mass point cloud data processing. Therefore, consistent with the present disclosure, only some sets of 3D point cloud data are manually annotated, while the remaining sets may be labeled automatically by system 200. The post-annotation data, including the label information and the 3D point cloud data, may be transmitted back via cable or wireless networks to system 200 for further processing and/or storage. Each set of point cloud data may be called a “frame” of the 3D point cloud data.

In some embodiments, system 200 according to the current closure may have processor 204 configured to receive two sets of 3D point cloud data that each includes an existing label of the object and may be called a “key frame.” The two key frames can be any frame in the sequence of 3D point data set, such as the first frame and the last frame. The two key frames are not adjacent to each other in the sequence of the plural sets of 3D point cloud data acquired by sensor 140, which means that there is at least one other set of 3D point cloud data acquired between the two sets being received. Moreover, processor 204 may be configured to calculate the difference between the labels of the object in those two key frames, and, based at least partially upon the result, determine an estimated label of the object in one or more sets of 3D point cloud data in the sequence that are acquired between the two key frames.

As shown in FIG. 2, processor 204 may include a frame reception unit 210. Frame reception unit 210 may be configured to receive one or more sets of 3D point cloud data via, for example, communication interface 202 or storage 206. In some embodiments, frame reception unit 210 may further have the capability to segment the received 3D point cloud data into multiple point cloud segments based on trajectory information 203 acquired by sensor 150, which may reduce the computation complexity and increase processing speed as to each set of 3D point cloud data.

In some embodiments consistent with the current disclosure, processor 204 may be further provided with a clock 208. Clock 208 may generate a clock signal that coordinates actions of the various digital components in system 200, including processor 204. With the clock signal, processor 204 may decide the time stamp and length of each of the frame it receives via communication interface 202. As a result, the sequence of multiple sets of 3D point cloud data may be aligned temporally with the clock information (e.g. time stamp) provided by clock 208 to each set. The clock information may further indicate the sequential position of each of the point cloud data set in a sequence of the sets. For example, if a LiDAR scanner capable of generating five sets of point cloud data per second surveys the surrounding environment for one minute, three hundred sets of point cloud data are generated. Using the clock signal input from clock 208, processor 204 may sequentially insert a time stamp to each of the three hundred sets to align the acquired point cloud sets from 1 to 300. Additionally, the clock signal may be used to assist association between frames of 3D point cloud data and frames of 2D images captured by sensor 160, which will be discussed later.

Processor 204 may also include a point cloud differentiation unit 212. Point cloud differentiation unit 212 may be configured to determine the difference between the labels of the object in the two received key frames. Several aspects of the labels in the two key frames may be compared. In some embodiments, the sequential difference of the labels may be calculated. The sequential position of the kₜₕ set of 3D point cloud data in a sequence of n different sets may be represented by fₖ, where k=1, 2, . . . , n. Thus, the difference of the sequential position between two key frames, which are respectively the lₜₕ and mₜₕ sets of 3D point cloud data, may be represented by Δfₗₘ, where 1=1, 2, . . . , n; and m=1, 2, . . . , n. Since the label information is integral with the information of the frame in which the label is annotated, the same representations applicable to the frames may also be used to represent the sequence and the difference of the sequential position with respect to the labels.

In some other embodiments, a change of the spatial position of the labels in the two key frames may also be compared and the difference be calculated. The spatial position of the labels may be represented by an n-dimensional coordinate system in a n-dimensional Euclidean space. For example, when the label is in a three-dimensional world, its spatial position may be represented by a three-dimensional coordinate system d(x, y, z). The label in the kₜₕ frame of the point cloud set sequence may therefore have a spatial position denoted as dₖ(x, y, z) in the three-dimensional Euclidean space. If the object labeled in the two key frames in a sequence of multiple sets of 3D point cloud data has relative movement with respect to the vehicle, it brings a change in the spatial position of the label relative to the vehicle. Such a spatial position change between the lₜₕ and mₜₕ frames may be represented by Δdₗₘ, where 1=1, 2, . . . , n; and m=1, 2, . . . , n.

Processor 204 may also include a label estimation unit 214. With the above descriptions of the sequential difference of the labels and the difference in the spatial position, an estimated label for the object in a non-annotated frame located between the two key frames may be subsequently determined by label estimation unit 214. In other words, a label may thus be calculated to cover substantially the same object in the non-annotated frame in the same sequence as those two key frames. Therefore, automatic labeling of the object in that frame is achieved.

Using the same sequence discussed above as an example, label estimation unit 214 acquires the sequential position fᵢ of the non-annotated frame in the point cloud set sequence by extracting the clock information (e.g. time stamp) attached to the clock signal from clock 208. In another example, label estimation unit 214 may obtain the sequential position fᵢ of the non-annotated frame by counting the numbers of the point cloud sets received by system 200 both before and after the non-annotated frame. Since the non-annotated frame is located between the two key frames in the point cloud set sequence, the sequential position fᵢ also locates between the two sequential positions fₗ and fₘ of the two respective key frames. After knowing the sequential position ft of the non-annotated frame, the label may be estimated to cover substantially the same object in that frame by calculating its spatial position in the three-dimensional Euclidean space using the following equation:

$${d}_{i} ( x , y , z ) = \frac{Δ {f}_{li}}{Δ {f}_{lm}} \times Δ {d}_{lm} + {d}_{l} ( x , y , z ) \qquad Eq . ( 1 )$$

where, dᵢ(x, y, z) represents the spatial position of the iₜₕ frame in which a label for the object is to be annotated; dₗ(x, y, z) represents the spatial position of the lₜₕ frame that is one of the two key frames; Δfₗₘ represents the differential sequential position between two key frames, i.e., the lₜₕ frame and the mₜₕ frame, respectively; Δfₗᵢ represents the differential sequential position between the iₜₕ frame and the lₜₕ frame; and Δdₗₘ, represents the differential spatial position between the two key frames.

In yet some other embodiments, other aspects of the labels may be compared, the difference of which may be calculated. For example, the volume of the object may change under some circumstances, and the volume of the label covering the object may change accordingly. These differential results may be additionally considered when determining the estimated label.

Consistent with the embodiments according to the current disclosure, label estimation unit 214 may be further configured to determine a ghost label of the object in one or more sets of 3D point cloud data in the sequence. A ghost label refers to a label applied to an object in a point cloud frame that is acquired either before or after the two key frames. Since the set containing the ghost label falls outside the range of point cloud sets acquired between the two key frames, prediction of the spatial position of the ghost label based on the differential spatial position between the two key frames is needed. For example, equations slightly revised from the above equation may be employed:

$$\begin{matrix}{d}_{g} ( x , y , z ) = {d}_{l} ( x , y , z ) - \frac{Δ {f}_{gl}}{Δ {f}_{l m}} \times Δ {d}_{l m} & Eq . ( 2 ) \\ {d}_{g} ( x , y , z ) = \frac{Δ {f}_{m g}}{Δ {f}_{l m}} \times Δ {d}_{l m} + {d}_{m} ( x , y , z ) & Eq . ( 3 )\end{matrix}$$

where, d_{g}(x, y, z) represents the spatial position of the gₜₕ frame in which a label for the object is to be annotated; Δf_{gl} represents the differential sequential position between the gₜₕ frame and the lₜₕ frame; and Δf_{mg} represents the differential sequential position between the mₜₕ frame and the gₜₕ frame, and all other denotations are the same as those in Eq. (1). Between the two equations, Eq. (2) may be used when the frame containing the ghost label precedes both key frames, while Eq. (3) may be used when the frame comes after them.

System 200 according to the current disclosure has the advantage of avoiding manual labeling of each set of 3D point cloud data in the point cloud data sequence. When system 200 receives two sets of 3D point cloud data with the same object manually labeled by a user, it may automatically apply a label to the same object in the other sets of 3D point cloud data in the same sequence that includes those two manually labeled frames.

In some embodiments consistent with the current disclosure, system 200 may optionally include an association unit 216 as part of processor 204, as shown in FIG. 2. Association unit 216 may associate plural sets of 3D point cloud data with plural frames of 2D images captured by sensor 160 and received by system 200. This allows system 200 to track the labeled object in 2D images, which is more intuitive to a human being than a voxel image consisting of point clouds. Furthermore, association of the annotated 3D point cloud frames with the 2D images may transfer the labels of an object from the 3D coordinate system automatically to the 2D coordinate system, therefore saving the effort to manually label the same object in the 2D images.

Similar to the embodiments where point cloud data 201 is discussed, communication interface 202 of system 200 may additionally send data to and receive data from components such as sensor 160 via cable or wireless networks. Communication device 202 may also be configured to transmit 2D images captured by sensor 160 among various components in or outside system 200, such as processor 204 and storage 206. In some embodiments, storage 206 may store a plurality of frames of 2D images captured by sensor 160 that are representative of the surrounding environment of vehicle 100. Sensors 140 and 160 may simultaneously operate to capture 3D point cloud data 201 and 2D images 205 both including the object to be automatically labeled and tracked, so that they can be associated with each other.

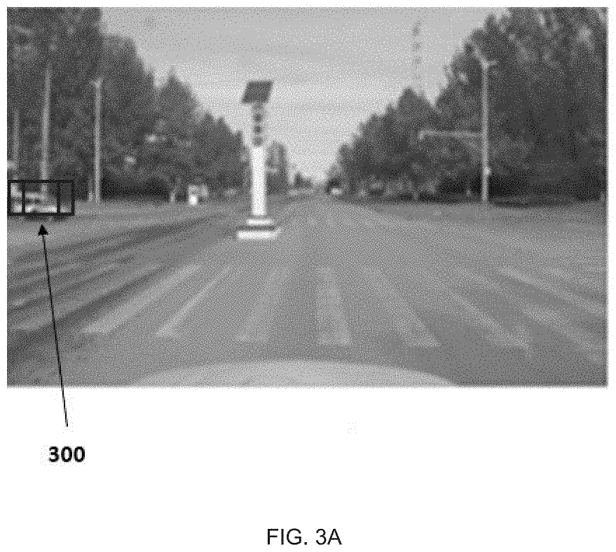

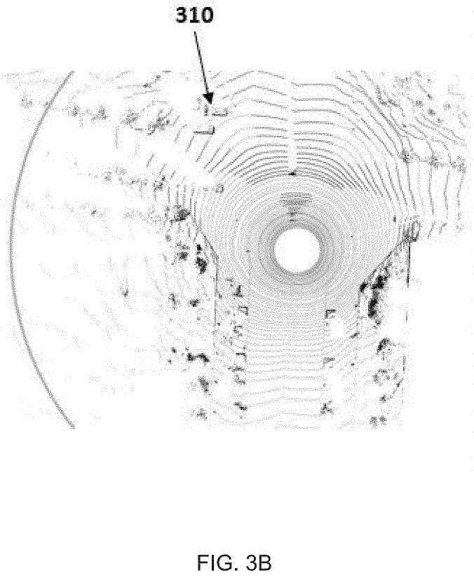

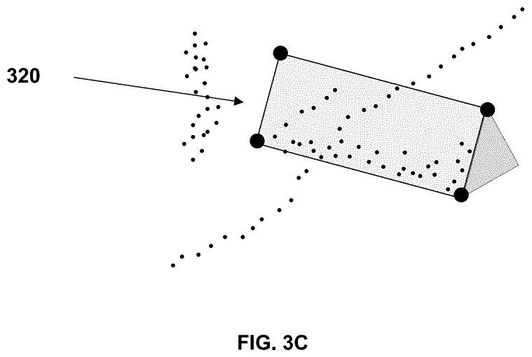

FIG. 3A illustrates an exemplary 2D image captured by an imaging sensor onboard vehicle 100. As one embodiment of the present disclosure, the imaging sensor is mounted on top of a vehicle traveling along a trajectory. As shown in FIG. 3A, there are a variety of objects captured in the image, including traffic lights, trees, cars, and pedestrians. Generally speaking, moving objects are of more concerns to a self-driving vehicle as compared to still objects, because recognition of a moving object and prediction of its traveling trajectory are more complicated, and avoiding such objects on the road requires more advanced tracking accuracy. The current embodiment provides a case where a moving object (e.g. car 300 in FIG. 3A) is accurately tracked in both 3D point clouds and 2D images without the onerous need to manually label the object in each and every frame of the 3D point cloud data and the 2D images. Car 300 in FIG. 3A is annotated by a bounding box, meaning that it is being tracked in the image. Unlike 3D point clouds, the depth information of the image may not be available in 2D images. Therefore, the position of a moving object in 2D images may be represented by a two-dimensional coordinate system (also known as “pixel coordinate system”), such as [u, v].

FIG. 3B illustrates an exemplary set of point cloud data associated with the exemplary 2D image in FIG. 3A. Number 310 in FIG. 3B is a label indicating the spatial position of car 300 in the three-dimensional point cloud set. Label 310 may be in the format of a 3D bounding box. As discussed above, the spatial position of car 300 in a 3D point cloud frame may be represented by a three-dimensional coordinate system (also known as “world coordinate system”) [x, y, z]. There exist various types of three-dimensional coordinate systems. The coordinate system according to the current embodiments may be selected as a Cartesian coordinate system. However, the current disclosure does not limit its application to only the Cartesian coordinate system. A person of ordinary skill in the art would know, with the teaching of the present disclosure, to select other suitable coordinate systems, such as a polar coordinate system, with a proper conversion matrix between the different coordinate systems. Additionally, label 310 may be provided with an arrow indicating the moving direction of car 300.

FIG. 3C illustrates an exemplary top view of the point cloud data set in FIG. 3B. FIG. 3C shows a label 320 indicating the spatial position of car 300 in this enlarged top view of the 3D point cloud frame in FIG. 3B. A large number of dots, or points, constitute the contour of car 300. Label 320 may be in the format of a rectangular box. When a user manually labels an object in the point cloud set, the contour helps the user identify car 300 in the point cloud set. Additionally, label 320 may further include an arrow indicating the moving direction of car 300.

Consistent with some embodiments according to the current disclosure, association unit 216 of processor 204 may be configured to associate the plural sets of 3D point cloud data with the respective frames of 2D images. The 3D point cloud data and the 2D images may or may not have the same frame rate. Regardless, association unit 216 according to the current disclosure may associate the point cloud sets and images of different frame rates. For example, sensor 140, a LiDAR scanner, may refresh the 3D point cloud sets at a rate of 5 frames per second (“fps”), while sensor 160, a video camera, may capture the 2D images at a rate of 30 fps. Therefore, in this example, each frame of the 3D point cloud frame is associated with 6 frames of the 2D images. Time stamps provided from clock 208 and attached to the point cloud sets and images may be analyzed when associating the respective frames.

In addition to the frame rate, association unit 216 may further associate the point cloud sets with the images by coordinate conversion, since they use different coordinate systems, as discussed above. When the 3D point cloud sets are annotated, either manually or automatically, the coordinate conversion may map the labels of an object in the 3D coordinate system to the 2D coordinate system and create labels of the same object therein. The opposite conversion and labeling, that is, mapping the labels of an object in the 2D coordinate system to the 3D coordinate system, can also be achieved. When the 2D images are annotated, either manually or automatically, the coordinate conversion may map the labels of an object in the 2D coordinate system to the 3D coordinate system.

According to the current disclosure, the coordinate mapping may be achieved by one or more transfer matrices, so that 2D coordinates of the object in the image frames and 3D coordinates of the same object in the point cloud frames may be converted to each other. In some embodiments, the conversion may use a transfer matrix. In some embodiments, the transfer matrix may be constructed with at least two different sub-matrices: an intrinsic matrix and an extrinsic evidence.

The intrinsic matrix,

$$[ \begin{matrix}f x & 0 & c x \\ 0 & f y & c y \\ 0 & 0 & 0\end{matrix} ]$$

may include parameters [fₓ, f_{y}, cₓ, c_{y}] that are intrinsic to sensor 160, which may be an imaging sensor. In the case of an imaging sensor, the intrinsic parameters may be various features of the imaging sensor, including focal length, image sensor format, and principal point. Any change in these features may result in a different set of intrinsic matrix. The intrinsic matrix may be used to calibrate the coordinates in accordance with the sensor system.

The extrinsic matrix,

$$[ \begin{matrix}r 11 & r 12 & r 13 & t 1 \\ r 21 & r 22 & r 23 & t 2 \\ r 31 & r 32 & r 33 & t 3\end{matrix} ]$$

may be used to transform 3D world coordinates into the three-dimensional coordinate system of sensor 160. The matrix contains parameters extrinsic to sensor 160, which means any change in the internal features of the sensor will not have any impact to these matrix parameters. These extrinsic parameters are relevant to the spatial position of the sensor in the world coordinate system, which may encompass the position and heading of the sensor. In some embodiments, the transfer matrix may be obtained by multiplying the intrinsic matrix and the extrinsic matrix. Accordingly, the following equation may be employed to map the 3D coordinates [x, y, z] of the object in the point cloud frames to 2D coordinates [u, v] of the same object in the image frames.

$$[ \begin{matrix}u \\ v \\ 1\end{matrix} ] = [ \begin{matrix}f x & 0 & c x \\ 0 & f y & c y \\ 0 & 0 & 0\end{matrix} ] \times [ \begin{matrix}r 11 & r 12 & r 13 & t 1 \\ r 21 & r 22 & r 23 & t 2 \\ r 31 & r 32 & r 33 & t 3\end{matrix} ] \times [ \begin{matrix}x \\ y \\ z \\ 1\end{matrix} ] \qquad Eq . ( 4 )$$

Through this coordinate conversion, association unit 216 may associate the point cloud data sets with the images. Moreover, labels of the object in one coordinate system, whether manually annotated or automatically estimated, may be converted into labels of the same object in another coordinate system. For example, bounding box 310 in FIG. 3B may be converted into a bounding box covering vehicle 300 in FIG. 3A.

In some embodiments, with the conversion matrices discussed above, the label estimation in the 3D point cloud data may be achieved by first estimating the label in its associated frame of 2D image and then converting the label back to the 3D point cloud. For example, for a selected set of 3D point cloud data in which no label is applied, it may be associated with a frame of 2D images. The sequential position of the frame of 2D images may be obtained from the clock information. Then, two frames of 2D images associated with two key point cloud frames (in which labels are already applied in, for example, the annotation interface) may be used to calculate the coordinate changes of the object in those two frames of 2D images. Afterwards, as the coordinate changes and the sequential position are known, an estimated label of the object in the insert frame corresponding to the selected set of 3D point cloud data may be determined, and an estimated label of the same object in the selected point data set may be converted from the estimated label in the image frame using the conversion matrices.

Consistent with some embodiments, for the object being tracked, processor 204 may be further configured to assign an object identification number (ID) to the object both in the 2D images and the 3D point cloud data. The ID number may further indicate a category of the object, such as a vehicle, a pedestrian, or a stationary object (e.g., a tree, a traffic light), etc. This may help system 200 predict the potential movement trajectory of the object while performing automatic labeling. In some embodiments, processor 204 may be configured to recognize the object, and thereafter to assign a proper object ID, in all frames of 2D images associated with the multiple sets of 3D point cloud data. The object may be recognized, for example, by first associating two annotated key point cloud frames with two images that have the same time stamp as the key point cloud frames. Thereafter, an object ID may be added to the object by comparing its contours, movement trajectory, and other features with preexisting repository of possible categories of objects and assigning an object ID proper to the comparison result. A person of ordinary skill in the art would know how to choose other methods to achieve the same object ID assignment in view of the teaching of the current disclosure.

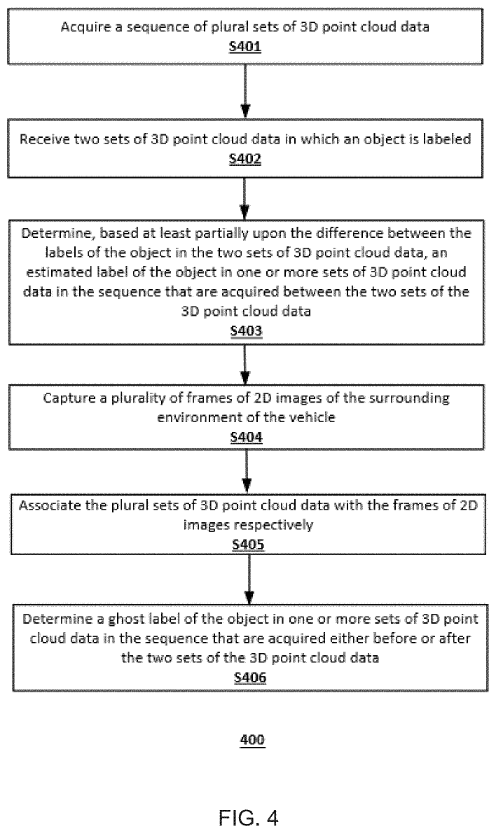

FIG. 4 illustrates a flow chart of an exemplary method 400 for labeling an object in point clouds. In some embodiments, method 400 may be implemented by system 200 that includes, among other things, a storage 206 and a processor 204 that includes a frame reception unit 210, a point cloud differentiation unit 212, and a label estimation unit 214. For example, step S402 of method 400 may be performed by frame reception unit 210, and step S403 may be performed by label estimation unit 214. It is to be appreciated that some of the steps may be optional to perform the disclosure provided herein, and that some steps may be inserted in the flowchart of method 400 that are consistent with other embodiments according to the current disclosure. Further, some of the steps may be performed simultaneously (e.g. S401 and S404), or in an order different from that shown in FIG. 4.

In step S401, consistent with embodiments according to the current disclosure, a sequence of plural sets (or frames) of 3D point cloud data may be acquired by one or more sensors associated with a vehicle. The sensor may be a LiDAR scanner that emits laser beams and map the environment by receiving the reflected pulse light to generate point clouds. Each set of 3D point cloud data may indicate positions of one or more objects in a surrounding environment of the vehicle. The plural sets of 3D point cloud data may be transmitted to a communication interface for further storage and processing. For example, they may be stored in a memory or storage coupled to the communication interface. They may also be sent to an annotation interface for a user to manually label any object reflected in the point cloud for tracking purpose.

In step S402, two sets of 3D point cloud data that each includes a label of the object may be received. For example, the two sets are selected among the plural sets of 3D point cloud data and annotated by a user to apply labels to the object therein. The point cloud sets may be transmitted from the annotation interface. The two sets are not adjacent to each other in the sequence of point cloud sets.

In step S403, the two sets may be further processed by differentiating the labels of the object in those two sets of 3D point cloud data. Several aspects of the labels in the two sets may be compared. In some embodiments, the sequential difference of the labels may be calculated. In other embodiments, the spatial position of the labels in the two sets represented by, for example, an n-dimensional coordinate of the label in a n-dimensional Euclidean space, may be compared and the difference be calculated. The more detailed comparison and calculation have been discussed above in conjunction with system 200 and therefore will not be repeated here. The result of the differentiation may be used to determine an estimated label of the object in one or more non-annotated sets of 3D point cloud data in the sequence that are acquired between the two annotated sets. The estimated label approximately covers substantially the same object in the non-annotated sets in the same sequence as the two annotated sets. Therefore, that frame is automatically labeled.

In step S404, according to some other embodiments of the current disclosure, a plurality of frames of 2D images may be captured by a sensor different from the sensor that acquires the point cloud data. The sensor may be an imaging sensor (e.g. a camera). The 2D images may indicate the surrounding environment of the vehicle. The captured 2D images may be transmitted between the sensor and the communication device via cable or wireless networks. They may also be forwarded to a storage for storage and subsequent processing.

In step S405, the plural sets of 3D point cloud data may be associated with the frames of 2D images respectively. In some embodiments, point cloud sets and images of different frame rates may be associated. In other embodiments, the association may be performed by coordinate conversion using one or more transfer matrices. A transfer matrix may include two different sub-matrices—one intrinsic matrix with parameters intrinsic to the imaging sensor and the other extrinsic matrix with parameters extrinsic to the imaging sensor that transform between 3D world coordinates and 3D sensor coordinates.

In step S406, consistent with embodiments according to the current disclosure, a ghost label of an object in one or more sets of 3D point cloud data in the sequence may be determined. These sets of 3D point cloud data are acquired either before or after the two annotated sets of the 3D point cloud data.

In yet some other embodiments, method 400 may include an optional step (not shown) where an objection ID may be attached to the object being tracked, in the 2D images and/or the 3D point cloud data.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc, a flash drive, or a solid-state drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A system for labeling an object in point clouds, comprising:
a storage medium configured to store a sequence of plural sets of three-dimensional (3D) point cloud data acquired by one or more sensors associated with a vehicle, each set of 3D point cloud data indicative of a position of the object in a surrounding environment of the vehicle; and
one or more processors configured to:
receive two sets of 3D point cloud data that each includes a label of the object, the two sets of 3D point cloud data not being adjacent to each other in the sequence; and
determine, based at least partially upon the difference between the labels of the object in the two sets of 3D point cloud data, an estimated label of the object in one or more sets of 3D point cloud data in the sequence that are acquired between the two sets of the 3D point cloud data.

2. The system of claim 1, wherein the storage medium is further configured to store a plurality of frames of two-dimensional (2D) images of the surrounding environment of the vehicle, captured by an additional sensor associated with the vehicle while the one or more sensors is acquiring the sequence of plural sets of 3D point cloud data, at least some of said frames of 2D images including the object; and
wherein the one or more processors are further configured to associate the plural sets of 3D point cloud data with the respective frames of 2D images.

3. The system of claim 2, wherein to associate the plural sets of 3D point cloud data with the plurality of frames of 2D images, the one or more processors are further configured to convert each 3D point cloud data between the 3D coordinates of the object in the 3D point cloud data and the 2D coordinates of the object in the 2D images based on at least one transfer matrix.

4. The system of claim 3, wherein the transfer matrix includes an intrinsic matrix and an extrinsic matrix,
wherein the intrinsic matrix includes parameters intrinsic to the additional sensor, and
wherein the extrinsic matrix transforms coordinates of the object between a 3D world coordinate system and a 3D camera coordinate system.

5. The system of claim 2, wherein the estimated label of the object in a selected 3D point cloud data is determined based upon the coordinate changes of the object in two key frames of 2D images associated with the two sets of 3D point cloud data in which the object is already labeled, and the sequential position of an insert frame associated with the selected 3D point cloud data relative to the two key frames.

6. The system of claim 5, wherein the two key frames are selected as the first and last frames of 2D images in the sequence of captured frames.

7. The system of claim 1, wherein the one or more processors are further configured to determine a ghost label of the object in one or more sets of 3D point cloud data in the sequence that are acquired either before or after the two sets of the 3D point cloud data.

8. The system of claim 2, wherein the one or more processors are further configured to attach an object identification number (ID) to the object and to recognize the object ID in all frames of 2D images associated with the plurality sets of 3D point cloud data.

9. The system of claim 1, wherein the one or more sensors include a light detection and ranging (LiDAR) laser scanner, a global positioning system (GPS) receiver, and an internal measurement unit (IMU) sensor.

10. The system of claim 2, wherein the additional sensor further includes an imaging sensor.

11. A method for labeling an object in point clouds, comprising:
acquiring a sequence of plural sets of 3D point cloud data, each set of 3D point cloud data indicative of a position of an object in a surrounding environment of a vehicle;
receiving two sets of 3D point cloud data in which the object is labeled, the two sets of 3D point cloud data not being adjacent to each other in the sequence; and
determining, based at least partially upon the difference between the labels of the object in the two sets of 3D point cloud data, an estimated labeling of the object in one or more sets of 3D point cloud data in the sequence that are acquired between the two sets of the 3D point cloud data.

12. The method of claim 11, further comprising:
capturing, while acquiring the sequence of plural sets of 3D point cloud data, a plurality of frames of 2D images of the surrounding environment of the vehicle, said frames of 2D images including the object; and
associating the plural sets of 3D point cloud data with the respective frames of 2D images.

13. The method of claim 12, wherein associating the plural sets of 3D point cloud data with the plurality of frames of 2D images includes conversion of each 3D point cloud data between the 3D coordinates of the object in the 3D point cloud data and the 2D coordinates of the object in the 2D images based on at least one transfer matrix.

14. The method of claim 13, wherein the transfer matrix includes an intrinsic matrix and an extrinsic matrix,
wherein the intrinsic matrix includes parameters intrinsic to a sensor capturing the plurality of frames of 2D image, and
wherein the extrinsic matrix transforms coordinates of the object between a 3D world coordinate system and a 3D camera coordinate system.

15. The method of claim 12, wherein the estimated labeling of the object in a selected 3D point cloud data is determined based upon the coordinate changes of the object in two key frames of 2D images associated with the two sets of 3D point cloud data in which the object is already labeled, and the sequential position of an insert frame associated with the selected 3D point cloud data relative to the two key frames.

16. The method of claim 15, wherein the two key frames are selected as the first and last frames of 2D images in the sequence of captured frames.

17. The method of claim 11, further comprising:
determining a ghost label of the object in one or more sets of 3D point cloud data in the sequence that are acquired either before or after the two sets of the 3D point cloud data.

18. The method of claim 12, further comprising:
attaching an object identification number (ID) to the object; and
recognizing the object ID in all frames of 2D images associated with the plurality sets of 3D point cloud data.

19. A non-transitory computer-readable medium having instructions stored thereon that, when executed by one or more processors, causes the one or more processors to perform operations comprising:
acquiring a sequence of plural sets of 3D point cloud data, each set of 3D point cloud data indicative of a position of an object in a surrounding environment of a vehicle;
receiving two sets of 3D point cloud data in which the object is labeled, the two sets of 3D point cloud data not being adjacent to each other in the sequence; and
determining, based at least partially upon the difference between the labels of the object in the two sets of 3D point cloud data, an estimated labeling of the object in one or more sets of 3D point cloud data in the sequence that are acquired between the two sets of the 3D point cloud data.

20. The non-transitory computer-readable medium of claim 19, wherein the operations further comprises:
capturing, while acquiring the sequence of plural sets of 3D point cloud data, a plurality of frames of 2D images of the surrounding environment of the vehicle, said frames of 2D images including the object; and
associating the plural sets of 3D point cloud data with the respective frames of 2D images.
